(19) United States
(12) Patent Application Publication
(10) Pub. No.: US 2021/0281082 A1
(43) Pub. Date: Sep. 9, 2021

(54) Universal Adaptive Charging Apparatus

(71) Applicant: Donny L. Workmon, Daytona Beach, FL (US)

(72) Inventor: Donny L. Workmon, Daytona Beach, FL (US)

(21) Appl. No.: 17/197,015

(22) Filed: Mar. 9, 2021

Related U.S. Application Data
(60) Provisional application No. 62/987,212, filed on Mar. 9, 2020.
(60) Provisional application No. 62/987,249, filed on Mar. 9, 2020.

(51) Int. Cl. H02J 7/00

(52) U.S. Cl. CPC H02J 7/0013; H02J 7/0034; H02J 2207/30; H02J 7/0047; H02J 7/0042

(57) ABSTRACT

A universal adaptive charging apparatus is used to interconnect multiple electronic devices to support recharging and data transfer between said devices. The universal adaptive charging apparatus utilizes an adapter shell an adapter shell, a plurality of indicator lights, a plurality of device connectors, a serial port, an external power cable, and a controller to facilitate and moderate the transfer of electrical power and data between all interconnected sources. The plurality of indicator lights and the plurality of device connectors are dispersed along the adapter shell to enable the controller to establish a connection to said devices whilst the plurality of indicator lights indicates the status of each device to the user. The controller is communicably coupled to the plurality of indicator lights, the plurality of device connectors, the serial port, and the external power cable, serving as a central node and junction for the universal adaptive charging apparatus.

The current application claims a priority to the U.S. Provisional Patent application Ser. No. 62/987,212 filed on Mar. 9, 2020 and a priority to the U.S. Provisional Patent application Ser. No. 62/987,249 filed on Mar. 9, 2020.

### FIELD OF THE INVENTION

The present invention relates generally to a charging apparatus, particularly a multi-appliance charging apparatus that comprises a plurality of cables and jacks thereof.

### BACKGROUND OF THE INVENTION

Presently, appliance chargers are conventionally constrained to a single power input means and a single output means. Wherein the appliance charger is further solely a cable or similar that is further limited to a single apparatus that can be charged. It is therefore the objective of the present invention to introduce a charging apparatus that utilizes a single body that comprises a plurality of cables and jacks thereof. Where the jacks correspond to variety of jacks. Where further the present invention introduces a plurality of lights embedded in the body. Where the plurality of lights corresponds to the plurality of cables to notify the user of the extraneous computing devices coupled to the present invention. Further, the present invention introduces at least one cord and power jack thereof to operate from a conventional power grid alongside at least one Universal Serial Bus (USB) jack to couple to an extraneous computing device to supply power to the plurality of cables. Further, at least one port is disposed that accommodates a memory storage device. Wherein the at least one port may facilitate data transmission between the memory storage device and any extraneous computing devices or appliances. Thus, the present invention accommodates a wide variety of extraneous computing devices or appliances through a plurality of cables and jacks thereof. Where the plurality of lights provides notification to the user regarding the status and docked state of the extraneous computing device. While further still the present invention introduces a plurality of powering means through the at least one USB jack and the at least one cord and power jack thereof.

### BRIEF DESCRIPTION OF THE DRAWINGS

FIG. 1 is a top-front-left perspective view of one embodiment of the present invention.

FIG. 2 is a front elevational perspective view thereof.

FIG. 3 is a rear elevational view thereof, wherein the internal components of the present invention are shown in outline.

FIG. 4 is top-front-left perspective view of an alternate embodiment of the present invention.

FIG. 5 is top-rear-right perspective view thereof.

FIG. 6 is a top-front-left perspective view thereof, wherein the present invention is configured to expose various operable components.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances, and should not be considered to be limiting to the scope of the present invention as a whole.

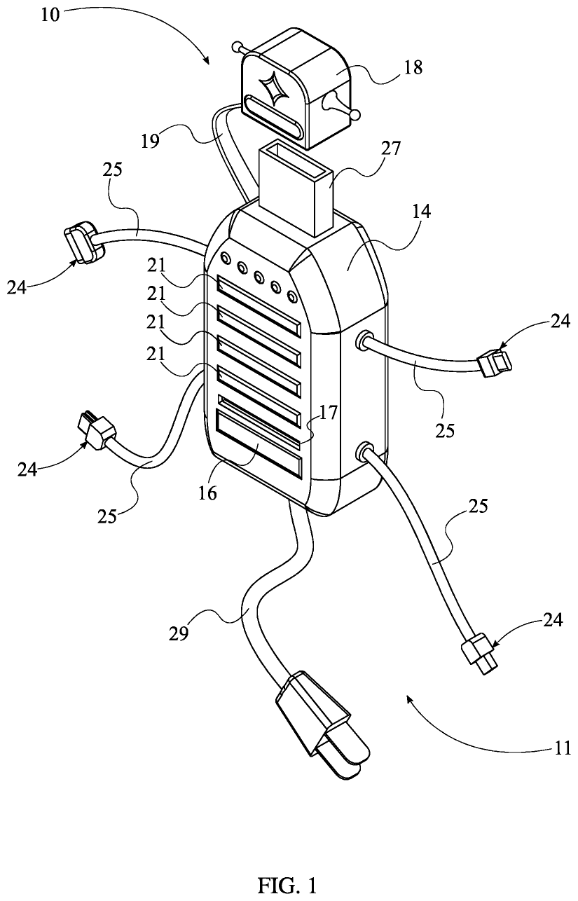

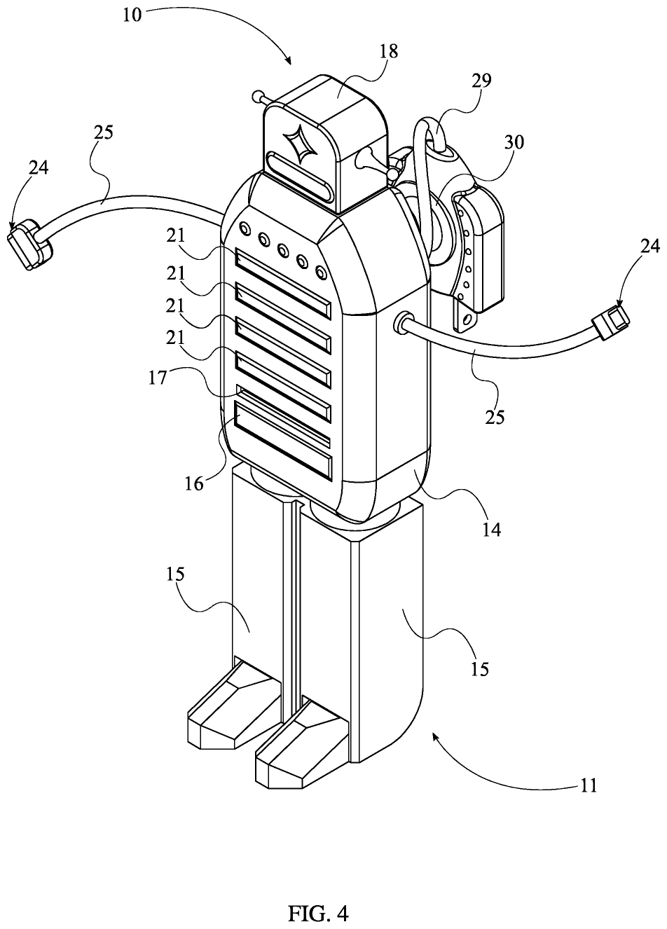

The universal adaptive charging apparatus comprises an adapter shell 14, a plurality of indicator lights 21, a plurality of device connectors 24, a serial port 27, an external power cable 29, and a controller 12. The adapter shell 14 extends between a serial end 10 and a supply end 11, defining a structural base for the conductive elements of the present invention. As shown in FIGS. 1 and 4, the adapter shell 14 may conform to a variety of potential embodiments and configurations according to the preferences of a manufacturer or user. According to the exemplary form shown the adapter shell 14 is ideally shaped into a roughly anthropomorphic profile, roughly defining the ‘torso’ of a robot figure while simultaneously supporting the functional features of the present invention. Further, the plurality of indicator lights 21 and the plurality of device connectors 24 are dispersed along the adapter shell 14 between the serial end 10 and the supply end 11, wherein each of the plurality of indicator lights 21 corresponds to one of the plurality of device connectors 24. This arrangement enables the plurality of device connectors 24 to be linked to a variety of devices (smartphones, tablets, personal computers, etc.) without at a variety of positions, ideally not limited by the form factor of the adapter shell 14 or any other fixed element of the present invention. The plurality of indicator lights 21 is configured to indicate activity across the plurality of device connectors 24, enabling a user to monitor the function of the present invention with a glance. Accordingly, the plurality of indicator lights 21 is dispersed across exposed regions of the present invention to improve visibility to a user. Additionally, the serial port 27 is connected to the serial end 10 of the adapter body to enable the present invention to connect directly to an external terminal or personal computer. Ideally, the serial port 27 defines a standard Universal Serial Bus connector to allow for maximal compatibility with existing hardware, but this should not be construed as a limitation to the potential embodiments of the present invention.

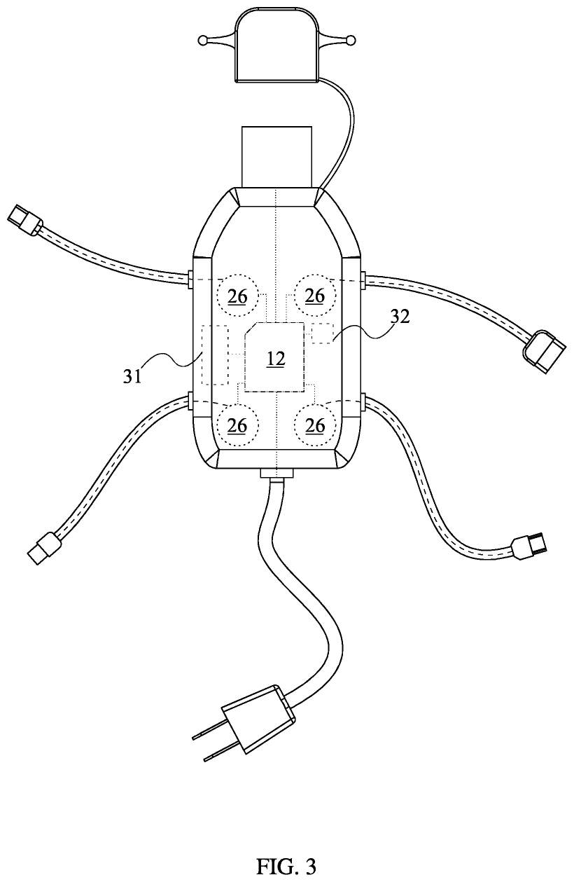

The achieve the functions of a charging device, the present invention must initially receive electrical power from some external source. Accordingly, the external power cable 29 traverses into the adapter shell 14 to enable the distribution of power throughout the resent invention. As illustrated in FIG. 3, the controller 12 is positioned within the adapter shell 14 and is communicably coupled to the plurality of indicator lights 21, the plurality of device connectors 24, the serial port 27, and the external power cable 29. More specifically, the controller 12 is configured to manage a data connection between each of the plurality of device connectors 24 and the serial port 27. The controller 12 is also configured to manage electrical power transfer from the external power cable 29 to each of the plurality of device connectors 24. In the preferred embodiment, the controller 12 constitutes a unitary microprocessor or other comparable computing unit that is capable of moderating data and electrical power transfers between the interconnected components of the present invention. This centralization of data and power transfer allows the controller 12 to actively moderate all functions of the present invention from a single junction, minimizing the necessary processing units when compared to a dispersed management system.

The present invention is, in one instance, connected between multiple devices through plurality of device connectors 24, allowing said devices to be recharged at optimal rates according to each individual device. Further, the transfer of data between each interconnected device may be facilitated in the same configuration. Therefore, a user must be able to determine if a device is charging, fully charged, transmitting, or receiving data to ensure that each device is properly linked to the present invention. Accordingly, each of the plurality of device connectors 24 is electrically connected to one of the plurality of indicator lights 21 to enable a user to easily ascertain the status of all connected devices by referring to the plurality of indicator lights 21. The controller 12 is ideally utilized to trigger appropriate status updates through the plurality of indicator lights 21 that are immediately identifiable by a user (e.g., solid green for fully charged devices, red for charging, flashing yellow for data connections, etc.). More specifically, the controller 12 is electronically coupled between the plurality of device connectors 24 and the plurality of indicator lights 21, wherein the plurality of device connectors 24 and the plurality of indicator lights 21 are coupled to each other through the controller 12.

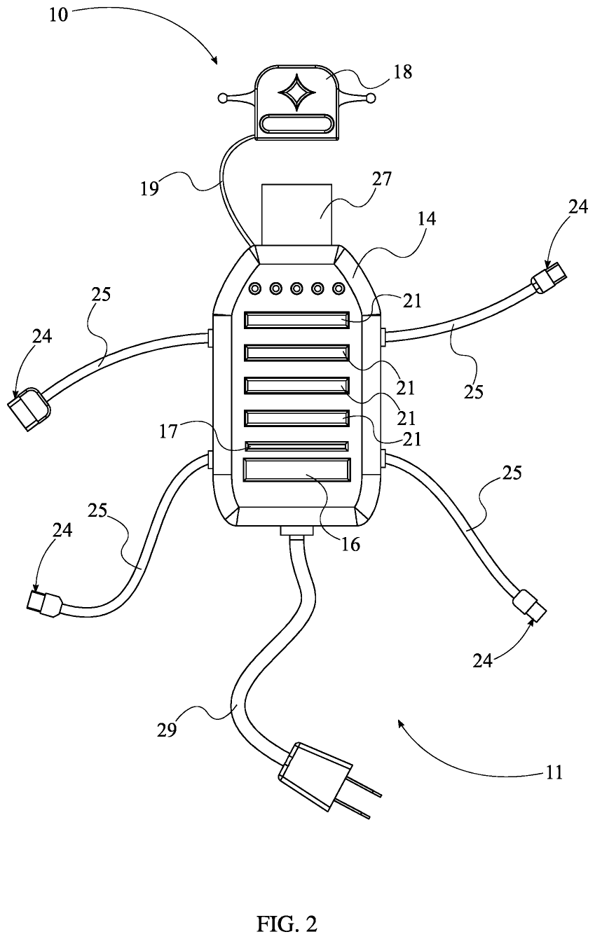

In the preferred embodiment shown in FIGS. 1 and 2, each of the plurality of device connectors 24 is positioned adjacent and oriented orthogonal to a corresponding indicator light from the plurality of indicator lights 21 about the adapter body between the serial end 10 and the supply end 11. In this arrangement, a user may immediately ascertain which of the plurality of indicator lights 21 corresponds to each of the device connectors, and vice versa, based on their immediate proximity.

As shown in FIG. 3, each of the device connectors may further comprise a data cable 25 to enable the connection of multiple devices that may otherwise occlude portion of the present invention if directly attached. To prevent the user from tangling, damaging, or misidentifying any of the plurality device connectors, a means of retaining each data cable 25 substantially within the adapter shell 14 is provided by the present invention. More specifically, the data cable 25 is deployably wound onto a spool 26, wherein the spool 26 operably withdraws the data cable 25 into the adapter shell 14. Each spool 26 ideally constitutes a self-winding drum with suitable clearance within the adapter shell 14 to store the full length of each data cable 25, leaving only the terminal end of each of the plurality of device connectors 24 exposed.

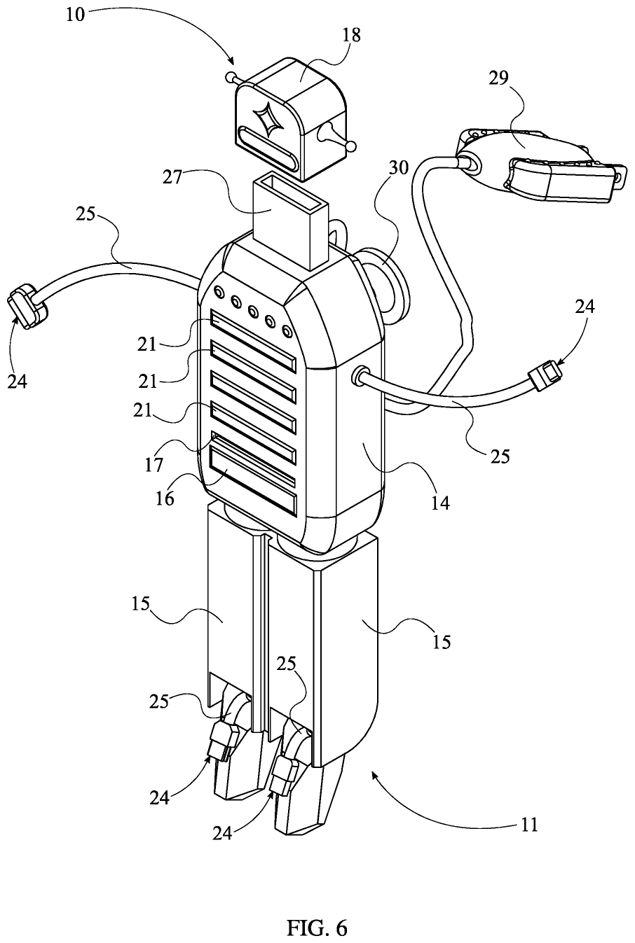

In at least one potential embodiment, the present invention provides a means of reading expandable storage devices or other insertable media. Accordingly, the present invention may further comprise at least one accessory port 17 traversing into the adapter shell 14 between the serial end 10 and the supply end 11. The at least one accessory port 17 is communicably coupled to the controller 12 to enable the media inserted into he at least one accessory port 17 to be read and transferred to any other connected device with the serial port 27 and the plurality of device connectors 24. As shown in FIGS. 4 and 6, an arbitrary indicator light 22 from the plurality of indicator lights 21 is electronically coupled to the accessory port 17 through the controller 12. This arrangement enables the arbitrary indicator light 22 to indicate the status of the at least one accessory port 17 in the same way that the plurality of indicator lights 21 indicates the status of the plurality of device connectors 24, as previously outlined.

As shown in FIG. 1 through 3, the present invention may further comprise a protective cap 18 and a cap tether 19. The protective cap 18 is removably mounted over the serial port 27 and the cap tether 19 is connected between the adapter shell 14 and the protective cap 18. The protective cap 18 defines any impermeable covering suitable for preventing the accumulation of dust, debris, and moisture in the serial port 27, thereby improving the durability of the present invention overall. In the exemplary embodiments shown, the protective cap 18 may further conform to the anthropomorphized theme of the present invention, wherein the protective cap 18 defines the ‘head’. The cap tether 19 is configured to prevent the separation of the protective cap 18 from the adapter body, preventing the loss of the protective cap 18 whilst the serial port 27 is in use.

As outlined in FIG. 3, the present invention may further comprise an internal power supply 31 electrically coupled to the controller 12, wherein the controller 12 is configured to manage electrical power flow from the serial port 27 and the external power cable 29 to the internal power supply 31. In the preferred embodiment, the internal power supply 31 defines a cellular battery of indeterminate capacity and the controller 12 operates as a battery management system to ensure that the internal power supply 31 can effectively recharge from an external source. Further, the controller 12 is configured to manage electrical power transfer from the internal power supply 31 to the plurality of device connectors 24, enabling the internal power supply 31 to provide electrical power throughout the present invention and to external devices.

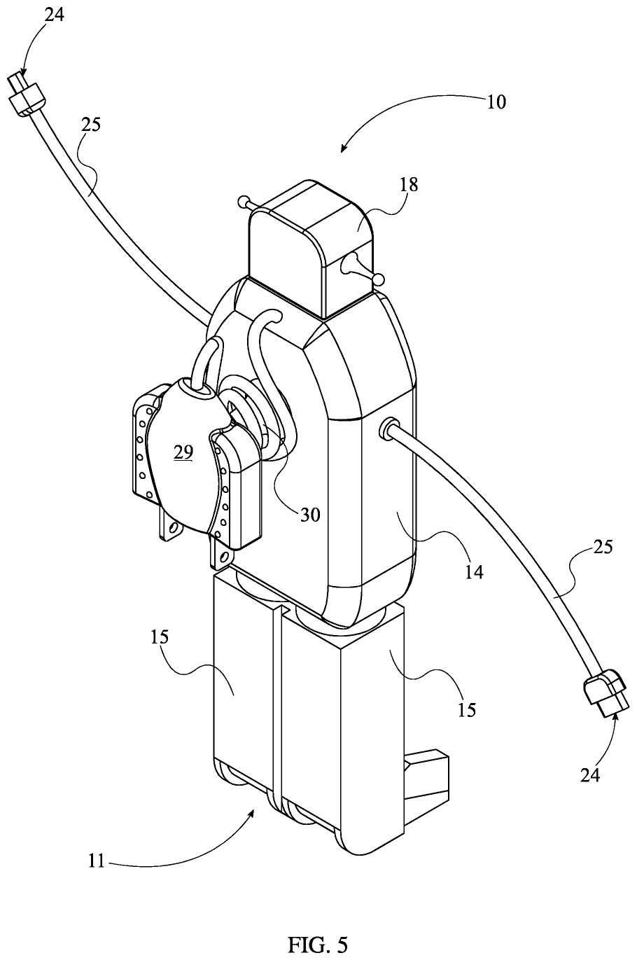

As shown in FIG. 4 through 6, the present invention may further comprise at least one protruding member 15 mounted to the adapter shell 14 between the serial end 10 and the supply end 11. The protruding member 15 ideally defines an elongate structural element that may be configured to support the adapter shell 14 as a stand, hook, clasp, or other fixed mount. In the embodiment shown, the at least one protruding member 15 constitutes a pair of robotic ‘legs’ supporting the adapter shell 14. This embodiment further exemplifies the anthropomorphized features of the present invention, ideally including other forms such as arms, tails, a neck, or other pseudo-limbs across various embodiments. As shown in FIG. 6, at least one of the plurality of device connectors 24 traverses through the protruding member 15 between the adapter shell 14 and a distal end of the protruding member 15. In the exemplary embodiment, the distal end of the protruding member 15 defines an exposed ‘ankle’ joint such that the plurality of device connectors 24 may extend therethrough.

Referring to FIG. 4 through 6, the external power cable 29 may be wound into a stowed configuration while not in use. Accordingly, a cable retainer 30 is mounted to the adapter shell 14 adjacent to the external power cable 29, wherein the external power cable 29 is removably engaged to the cable retainer 30. The cable retainer 30 ideally constitutes a static post mounted to the adapter shell 14 as shown, though the cable retained may define any comparable or equivalent cable management hardware without departing from the spirit and scope of the present invention.

In addition to the plurality of indicator lights 21, the present invention may comprise at least one display panel 16 to impart information to a user. Further, the present invention may comprise a system clock 32, wherein the controller 12 is communicably coupled between the system clock 32 and the display panel 16. In one configuration, the system clock 32 is configured to track time and date information and output the time and date information to the display panel 16. In another configuration, the system clock 32 may be used to track individual operations supported by the present invention (i.e., charging, data transfers, etc.) and output status updates to the display panel 16.

Although the invention has been explained in relation to its preferred embodiment, it is to be understood that many other possible modifications and variations can be made without departing from the spirit and scope of the invention as hereinafter claimed.

What is claimed is:

1. A universal adaptive charging apparatus comprising:
an adapter shell;
a plurality of indicator lights;
a plurality of device connectors;
a serial port;
an external power cable;
a controller;
the adapter shell extending between a serial end and a supply end;
the plurality of indicator lights and the plurality of device connectors being dispersed along the adapter shell between the serial end and the supply end, wherein each of the plurality of indicator lights corresponds to one of the plurality of device connectors;
the serial port being connected to the serial end of the adapter body;
the external power cable traversing into the adapter shell;
the controller being positioned within the adapter shell;
the controller being communicably coupled to the plurality of indicator lights, the plurality of device connectors, the serial port, and the external power cable;
the controller being configured to manage a data connection between each of the plurality of device connectors and the serial port; and
the controller being configured to manage electrical power transfer from the external power cable to each of the plurality of device connectors.

2. The universal adaptive charging apparatus as claimed in claim 1 comprising:
each of the plurality of device connectors being electrically connected to one of the plurality of indicator lights; and
the controller being electronically coupled between the plurality of device connectors and the plurality of indicator lights, wherein the plurality of device connectors and the plurality of indicator lights are coupled to each other through the controller.

3. The universal adaptive charging apparatus as claimed in claim 1 comprising:
each of the plurality of device connectors being positioned adjacent and oriented orthogonal to a corresponding indicator light from the plurality of indicator lights about the adapter body between the serial end and the supply end.

4. A universal adaptive charging apparatus as claimed in claim 1 comprising:
each of the plurality of device connectors further comprising a data cable; and
the data cable being deployably wound onto a spool, wherein the spool operably withdraws the data cable into the adapter shell.

5. The universal adaptive charging apparatus as claimed in claim 1 comprising:
at least one accessory port;
the at least one accessory port traversing into the adapter shell between the serial end and the supply end; and
the at least one accessory port being communicably coupled to the controller;
an arbitrary indicator light from the plurality of indicator lights being electronically coupled to the accessory port through the controller.

6. The universal adaptive charging apparatus as claimed in claim 1 comprising:
a protective cap;
a cap tether;
the protective cap being removably mounted over the serial port; and
the cap tether connecting between the adapter shell and the protective cap.

7. The universal adaptive charging apparatus as claimed in claim 1 comprising:
an internal power supply;
the internal power supply being electrically coupled to the controller;
the controller being configured to manage electrical power flow from the serial port and the external power cable to the internal power supply; and
the controller being configured to manage electrical power transfer from the internal power supply to the plurality of device connectors.

8. The universal adaptive charging apparatus as claimed in claim 1 comprising:
at least one protruding member being mounted to the adapter shell between the serial end and the supply end; and
at least one of the plurality of device connectors traversing through the protruding member between the adapter shell and a distal end of the protruding member.

9. The universal adaptive charging apparatus as claimed in claim 1 comprising:
a cable retainer being mounted to the adapter shell adjacent to the external power cable; and
the external power cable being removably engaged to the cable retainer.

10. The universal adaptive charging apparatus as claimed in claim 1 comprising:
at least one display panel;
a system clock; and
the controller being communicably coupled between the system clock and the display panel, wherein the system clock is configured to track time and date information and output the time and date information to the display panel.

11. A universal adaptive charging apparatus comprising:
an adapter shell;
a plurality of indicator lights;
a plurality of device connectors;
a serial port;
an external power cable;
a controller;
the adapter shell extending between a serial end and a supply end;
the plurality of indicator lights and the plurality of device connectors being dispersed along the adapter shell between the serial end and the supply end, wherein each of the plurality of indicator lights corresponds to one of the plurality of device connectors;
the serial port being connected to the serial end of the adapter body;
the external power cable traversing into the adapter shell;
the controller being positioned within the adapter shell;
the controller being communicably coupled to the plurality of indicator lights, the plurality of device connectors, the serial port, and the external power cable;
the controller being configured to manage a data connection between each of the plurality of device connectors and the serial port;
the controller being configured to manage electrical power transfer from the external power cable to each of the plurality of device connectors;
each of the plurality of device connectors being electrically connected to one of the plurality of indicator lights; and
the controller being electronically coupled between the plurality of device connectors and the plurality of indicator lights, wherein the plurality of device connectors and the plurality of indicator lights are coupled to each other through the controller.

12. The universal adaptive charging apparatus as claimed in claim 11 comprising:
each of the plurality of device connectors being positioned adjacent and oriented orthogonal to a corresponding indicator light from the plurality of indicator lights about the adapter body between the serial end and the supply end.

13. The universal adaptive charging apparatus as claimed in claim 11 comprising:
each of the plurality of device connectors further comprising a data cable; and
the data cable being deployably wound onto a spool, wherein the spool operably withdraws the data cable into the adapter shell.

14. The universal adaptive charging apparatus as claimed in claim 11 comprising:
at least one accessory port;
the at least one accessory port traversing into the adapter shell between the serial end and the supply end; and
the at least one accessory port being communicably coupled to the controller;
an arbitrary indicator light from the plurality of indicator lights being electronically coupled to the accessory port through the controller.

15. The universal adaptive charging apparatus as claimed in claim 11 comprising:
a protective cap;
a cap tether;
the protective cap being removably mounted over the serial port; and
the cap tether connecting between the adapter shell and the protective cap.

16. The universal adaptive charging apparatus as claimed in claim 11 comprising:
an internal power supply;
the internal power supply being electrically coupled to the controller;
the controller being configured to manage electrical power flow from the serial port and the external power cable to the internal power supply; and
the controller being configured to manage electrical power transfer from the internal power supply to the plurality of device connectors.

17. The universal adaptive charging apparatus as claimed in claim 11 comprising:
at least one protruding member being mounted to the adapter shell between the serial end and the supply end; and
at least one of the plurality of device connectors traversing through the protruding member between the adapter shell and a distal end of the protruding member.

18. The universal adaptive charging apparatus as claimed in claim 11 comprising:
a cable retainer being mounted to the adapter shell adjacent to the external power cable; and
the external power cable being removably engaged to the cable retainer.

19. The universal adaptive charging apparatus as claimed in claim 11 comprising:
at least one display panel;
a system clock; and
the controller being communicably coupled between the system clock and the display panel, wherein the system clock is configured to track time and date information and output the time and date information to the display panel.
